(19) United States
(12) Patent Application Publication
(10) Pub. No.: US 2009/0034645 A1
(43) Pub. Date: Feb. 5, 2009

(54) SYSTEM AND METHOD FOR GAIN WEIGHTED CODE COMBINING FOR TWO BINARY PHASE SHIFT KEYING CODES

(76) Inventor: Isaac Ming-En Jeng, Yorba Linda, CA (US)

Correspondence Address: HARNESS DICKEY & PIERCE, PLC, P.O. BOX 828, BLOOMFIELD HILLS, MI, 48303, US

(21) Appl. No.: 11/831,405

(22) Filed: Jul. 31, 2007

(51) Int. Cl. H04L 27/18

(52) U.S. Cl. 375/279

(57) ABSTRACT

A method and system for generating a composite binary phase shift keying (BPSK) code from two independent component BPSK codes that is representative of the two component BPSK codes. In one implementation the method involves gain weighting each of the first and second component BPSK codes by its respective code power ratio to form first and second gain weighted codes. The first and second gain weighted codes are processed in accordance with an algorithm to form a composite BPSK code. The composite BPSK code has a fifty to seventy-five percent probability of matching each one of the BPSK codes. A system for generating a composite BPSK code from two BPSK codes is also disclosed.

### CROSS-REFERENCE TO RELATED APPLICATIONS

This application is related to U.S. patent application Ser. No. ______ (Boeing 07-0488; HDP 7784-001068), filed concurrently herewith. The disclosure of the above application is incorporated herein by reference.

### STATEMENT OF U.S. GOVERNMENT RIGHTS

The subject matter of the present disclosure was developed at least in part pursuant to a contract with the U.S. Air force pursuant to contract number FA8807-04-C-0002. The U.S. Government has certain rights in the subject matter of the present disclosure.

### FIELD

The present disclosure relates to binary phase shift keying (BPSK) code combining systems and methods, and more particularly to a combining system and method for combining two component BPSK codes to form a single, composite BPSK code that is representative of the two component BPSK codes.

### BACKGROUND

The statements in this section merely provide background information related to the present disclosure and may not constitute prior art.

Currently, the global positioning system GPS IIF transmits three binary phase shift keying (BPSK) codes using a modulation scheme known in the industry as “Interplex” modulation. The Interplex modulation scheme modulates three BPSK codes such that the modulated signal has a constant power. The GPS III system needs to transmit two additional BPSK codes. However, the transmitted signal still needs to have a constant power. Hence, these two additional codes need to be combined with the three original BPSK codes via some code combining technique, then modulated by the Interplex process such that the transmitted signal has a constant power.

One option includes the five codes involves using the Interlace combining scheme. The Interlace combining scheme can be used to combine the three BPSK codes into one, so the original total of five BPSK codes are reduced to three. These three codes can then be modulated using Interplex just like what is presently being done in GPS IIF. However, this technique suffers from certain limitations and drawbacks because it requires complex logic. For one, the existing Interlace combining technique requires a uniform distribution random number generator. Optimum performance of the Interlace combining technique depends on the authenticity (i.e., flatness) of the uniform random number generator (i.e., the degree to which the generated random numbers are uniformly distributed). In addition, when a uniform random number generator is utilized, a mapping table is required to make a selection for the current chip of the composite code between either the majority voted code (the code that is formed by the three component codes on the majority-vote basis) or one of the two BPSK component codes of higher code powers, depending on the magnitude of the random number. This process repeats whenever a random number is generated.

### SUMMARY

The present disclosure relates to a method and system for generating a composite BPSK code from a pair of potentially different component BPSK codes. In one implementation the method involves gain weighting first and second component BPSK codes by its respective code power ratio to form first and second gain weighted codes. The first and second gain weighted codes are processed in accordance with an algorithm to form a composite BPSK code. The composite BPSK code has a probability of fifty percent or greater of matching each one of the component BPSK codes.

In one specific implementation, gain weightings (also known as code power ratios) of the first and second component BPSK codes involve the operations of:

assigning a(t) to represent the first component BPSK code, where a(t) is a random BPSK code equally likely to be +1 or −1, and has the higher code power of the two component BPSK codes;

assigning b(t) to represent the second component BPSK code, where b(t) is a random BPSK code equally likely to be +1 or −1, and has a code power no more than the code power of the other component BPSK code;

determining code power ratios using the formulas:

$${g}_{a} = \frac{code power of a ( t )}{code power of c ( t )}$$

$${g}_{b} = \frac{code power of b ( t )}{code power of b ( t )} = 1$$

and where wherein gₐ and g_{b} are arranged such that:

gₐ≧g_{b}=1.

The composite BPSK code is represented by a term x(t), and determined in a chip-synchronous manner by the formula (where * denotes multiplication):

$$x ( t ) = sign \{ [ \sqrt{{g}_{a}} a ( t ) + b ( t ) - \frac{1}{2} {g}_{a} - \frac{1}{2} + \sqrt{{g}_{a}} a ( t ) * b ( t ) ] \} .$$

A system for generating a composite BPSK code from two component BPSK codes is also disclosed. Advantageously, the system does not require the use of a uniform random number generator or a mapping table.

The methods of the present disclosure provide combining efficiency that is related to the correlations between the composite BPSK code and each of the component BPSK codes. This combining efficiency, being less than 100%, can be practically interpreted as reductions of the effective code powers for each of the component BPSK codes. The correlation between the composite BPSK code and a component BPSK code will have a value that lies between −1 to 1 inclusive, and shows the resemblance of one with the other. When the correlation is close to 1, it means almost all the chips of the composite BPSK code and the respective chips of the component BPSK code are the same. The same conclusion applies when the correlation is close to −1, except that the two are 180-degree out of phase. When the correlation is close to zero, a very low percentage of the composite BPSK code chips and the respective component BPSK code chips are the same.

A method for determining the reduction of the effective code power for each of the component BPSK codes is disclosed, together with a method for compensating for these reductions.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a simplified block diagram of one embodiment of a system in accordance with the present disclosure;

FIG. 2 is a flowchart setting forth a plurality of exemplary operations of a method of the present disclosure for determining a composite BPSK code from a pair of potentially different component BPSK codes;

FIG. 3 is a table illustrating the probability of matching chips between the composite BPSK code and the component BPSK codes;

FIG. 4 is a table illustrating the probability of matching chips between the composite BPSK code and component BPSK codes for different code power ratios;

FIG. 5 is a graph illustrating the matching probability of each component BPSK code over the range of gₐ;

FIG. 6 is a table illustrating the probability of matching chips between the composite BPSK code and the component BPSK codes for different code power ratios;

FIGS. 7A and 7B are graphs illustrating the correlations of the composite BPSK code with itself and with the component BPSK codes.

FIGS. 8A and 8B are graphs illustrating the correlation between the composite BPSK code and the component BPSK codes but for different code power ratios;

FIGS. 9A and 9B are graphs illustrating the correlation between the composite BPSK code and the component BPSK codes for different code power ratios;

FIGS. 10A and 10B are additional graphs illustrating the correlation between the composite BPSK code and the component BPSK codes, and how the correlations drop virtually to zero when the code power ratios exceed a predetermined interval, the interval of matching probability 50% in FIG. 5; and

FIG. 11 is a diagram of the variables and operations that determine the power of the composite BPSK code.

### DETAILED DESCRIPTION

The following description is merely exemplary in nature and is not intended to limit the present disclosure, application, or uses.

The present disclosure relates to a method and system for generating a composite binary phase shift keying (BPSK) code from a pair of independent component BPSK codes. The composite BPSK code can then be transmitted as one BPSK code and is a representative of the two component BPSK codes.

Initially the two component BPSK codes are defined by assigning a(t) to represent the first component BPSK code, where a(t) is a random BPSK code equally likely to be +1 or −1, and has the higher code power of the two component BPSK codes. The term b(t) is assigned to represent the second component BPSK code, where b(t) is a random BPSK code equally likely to be +1 or −1, and has a code power no more than that of the first component BPSK code.

A code power ratio (also known as gain) associated with each of the component BPSK codes a(t) and b(t) is then determined by the following formulas:

$$\begin{matrix}{g}_{a} = \frac{code power of a ( t )}{code power of b ( t )} & Equation 1 \\ {g}_{b} = \frac{code power of b ( t )}{code power of b ( t )} = 1 & Equation 2\end{matrix}$$

and the code powers are in the descending order (i.e., power of a(t)≧power of b(t), and g_{b} is set equal to 1 (i.e., gₐ≧g_{b}=1).

Once the code powers ratios have been determined, and in view of the fact that g_{b} is set equal to 1, the following algorithm can be used in a chip-synchronous manner to determine the composite BPSK code (where * denotes multiplication):

$$x ( t ) = sign \{ [ \begin{matrix}\sqrt{{g}_{a}} a ( t ) + \sqrt{{g}_{b}} b ( t ) - \frac{1}{2} {g}_{a} {a}^{2} ( t ) - \\ \frac{1}{2} {g}_{b} {b}^{2} ( t ) + \sqrt{{g}_{a}} a ( t ) * \sqrt{{g}_{b}} b ( t )\end{matrix} ] \} \qquad Equation 3$$

By Equation 3, the component codes are respectively weighted by their code power ratios then multiplied, summed and thresholded to form the composite BPSK code x(t). Since the composite BPSK code may not fully represent both of the two component codes at any given time, the receiver of each component BPSK code may experience some correlation loss. The implementation of this combining and the amount of possible correlation loss will be discussed further in the following paragraphs.

Since g_{b}=1, and since:

a²(t)=b²(t)=1, the Equation 3 is simplified to: Equation 4

$$x ( t ) = sign \{ [ \begin{matrix}\sqrt{{g}_{a}} a ( t ) + b ( t ) - \frac{1}{2} {g}_{a} - \\ \frac{1}{2} + \sqrt{{g}_{a}} a ( t ) * b ( t )\end{matrix} ] \} . \qquad Equation 5$$

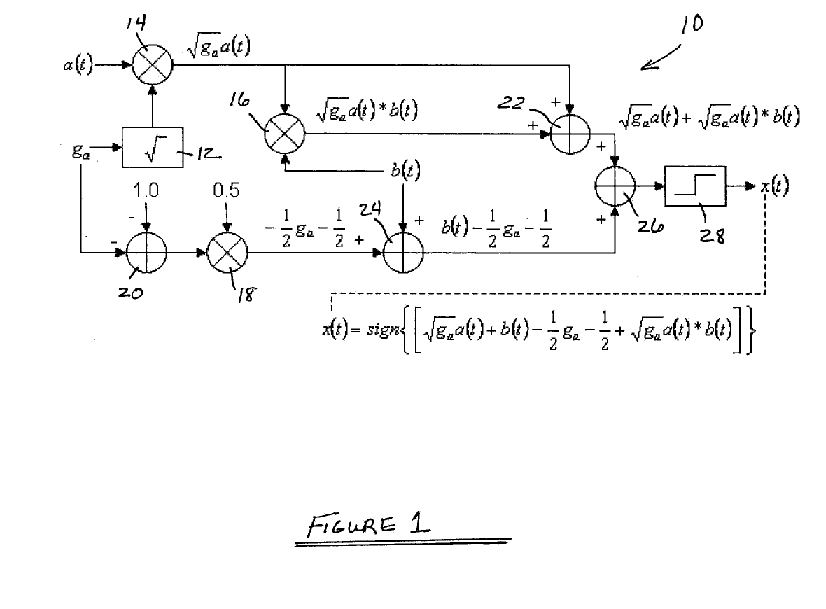

A system 10 in accordance with one embodiment of the present disclosure for implementing Equation 3 is illustrated in FIG. 1. The system 10 makes use of one square root determining circuit 12, three multiplier circuits 14, 16 and 18, four summing circuits 20, 22, 24 and 26, and a zero threshold comparing circuit 28. Alternatively, some or all of the functions 10 may be implemented by a suitably programmed computer processor. For convenience, portions of various equations that are performed by their corresponding components in system 10 are reproduced adjacent to their respective components.

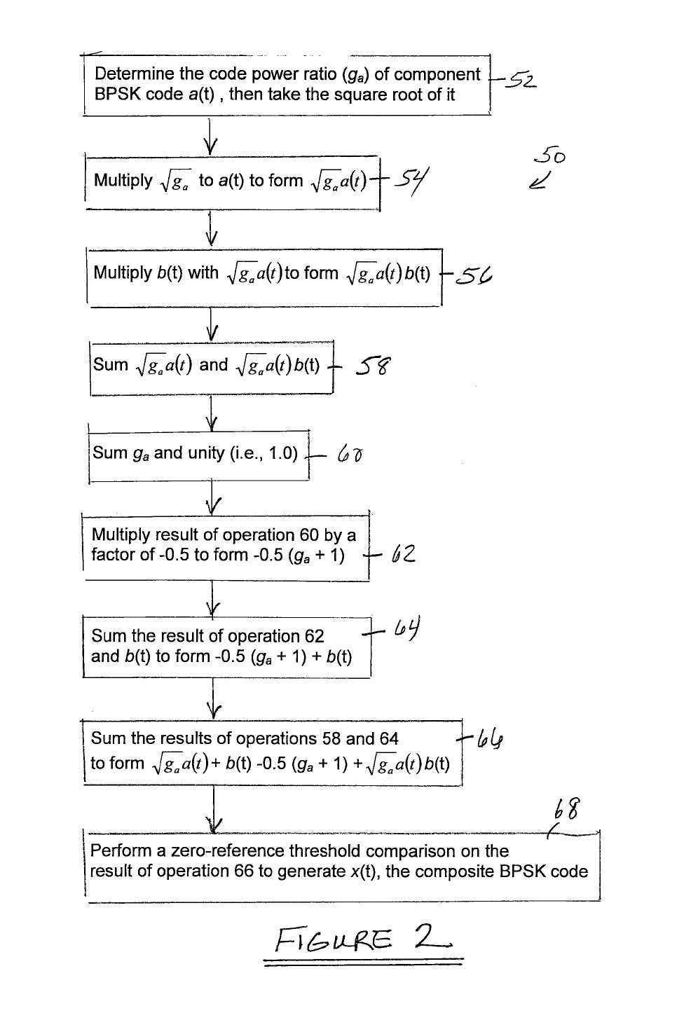

With reference to the flowchart 50 of FIG. 2 and the system 10 shown in FIG. 1, the operation of the system 10 will be described. At operation 52, first determine the code power ratio (gₐ) of component BPSK code a(t), then take the square root of it using square root circuit 12. At operation 54, multiply \sqrt{gₐ} and a(t) to form \sqrt{gₐ}a(t) using multiplier circuit 14. At operation 56, multiply b(t) with \sqrt{gₐ}a(t)to form \sqrt{gₐ}a(t)b(t) using multiplier circuit 16. At operation 58, sum \sqrt{gₐ}a(t) and \sqrt{gₐ}a(t)b(t) using summing circuit 22. At operation 60, negatively sum gₐ and unity (i.e., 1.0), using summing circuit 20. At operation 62, multiply result of operation 60 by a factor of 0.5 to form −0.5 (gₐ+1), using multiplier 18. At operation 64, sum the result of operation 62 and b(t) to form −0.5 (gₐ+1)+b(t) using summing circuit 24. At operation 66, sum the results of operations 58 and 64 to form \sqrt{gₐ}a(t)+b(t)−0.5 (gₐ+1)+\sqrt{gₐ}a(t)b(t) using summing circuit 26. At operation 68 perform a zero-reference threshold comparison on the result of operation 66, using zero threshold comparing circuit 28, to generate x(t), the composite BPSK code.

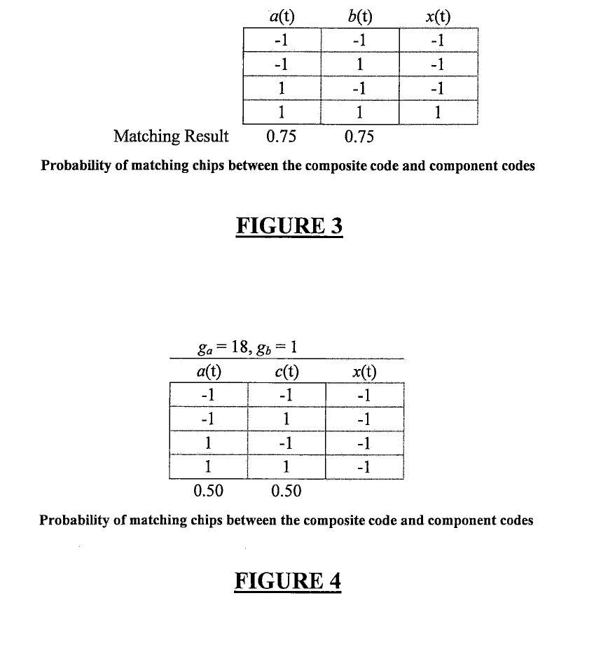

Referring to the table of FIG. 3, the composite BPSK code x(t) has the matching probabilities shown in the table of FIG. 3 if gₐ=g_{b}=1 (x(t) is the logical AND of a(t) and b(t)). By a “match”, it is meant that the product of a component code chip and its corresponding composite code chip is “1”; a mismatch is “−1”. Each component BPSK code matches the composite code 75% (i.e., on average each component BPSK code matches the composite BPSK code 3 out of 4 chips). When all 4 chips are matched, the correlation between a component BPSK code and the composite BPSK code would be

$${R}_{x , a} = {R}_{x , b} = \frac{4 ( 1 ) + 0 ( - 1 )}{4} = 1 = 0 dB . \qquad Equation 6$$

This is a perfect or “full” correlation. When the matching probability drops below 100%, perfect correlation is no longer achievable. For a matching probability of 75%, the impact on the correlation is shown below:

$${R}_{x , a} = {R}_{x , b} = \frac{3 ( 1 ) + 1 ( - 1 )}{4} = 0.50 = - 3 dB . \qquad Equation 7$$

Hence, a 75% matching probability translates to a 3 dB correlation loss. Note that each matching or mismatching chip increases or decreases the correlation, respectively.

If gₐ varies, the matching probabilities will also vary. For code power ratios gₐ=18 and g_{b}=1, the matching probabilities are shown in the table of FIG. 4. A matching probability of 50% means on average each component BPSK code matches the composite BPSK code two out of four chips. The correlation is reduced to zero:

$${R}_{x , a} = {R}_{x , b} = \frac{2 ( 1 ) + 2 ( - 1 )}{4} = 0 = - ∞ dB . \qquad Equation 8$$

Since the code power ratio gₐ between the component BPSK codes changes the correlation between the composite BPSK code and each component BPSK code, one will need to ascertain the range of gₐ and the corresponding matching probabilities for the component codes. This development is shown below from Equation 9:

$$x ( t ) = sign \{ [ \begin{matrix}\sqrt{{g}_{a}} a ( t ) + b ( t ) - \frac{1}{2} {g}_{a} - \\ \frac{1}{2} + \sqrt{{g}_{a}} a ( t ) * b ( t )\end{matrix} ] \} . \qquad Equation 9$$

Since the composite BPSK code x(t) changes from 1 to −1 at some gain gₐwhen a(t)=b(t)=1, it can be shown that:

$$x ( t ) = sign \{ [ 2 \sqrt{{g}_{a}} - \frac{1}{2} {g}_{a} + \frac{1}{2} ] \} = \{ \begin{matrix}1 \\ 0 \\ - 1\end{matrix} \qquad Equation 10$$

depends on the gain ratios and it can be interpreted as

$$\begin{matrix}2 \sqrt{{g}_{a}} - \frac{1}{2} {g}_{a} + \frac{1}{2} \frac{>}{<} 0 & Equation 11 \\ 4 \sqrt{{g}_{a}} + 1 \frac{>}{<} {g}_{a} \\ Hence & Equation 12 \\ \frac{4 \sqrt{{g}_{a}} + 1}{{g}_{a}} \frac{>}{<} 1 & Equation 13\end{matrix}$$

The implication is that

$$\begin{matrix}x ( t ) = sign [ 2 \sqrt{{g}_{a}} - \frac{1}{2} {g}_{a} + \frac{1}{2} ] \\ = \{ \begin{matrix}1 and 75 \% matching & if & \frac{4 \sqrt{{g}_{a}} + 1}{{g}_{a}} > 1 \\ 0 and 50 \% matching & if & \frac{4 \sqrt{{g}_{a}} + 1}{{g}_{a}} = 1 \\ - 1 and 50 \% matching & if & \frac{4 \sqrt{{g}_{a}} + 1}{{g}_{a}} < 1\end{matrix}\end{matrix}$$

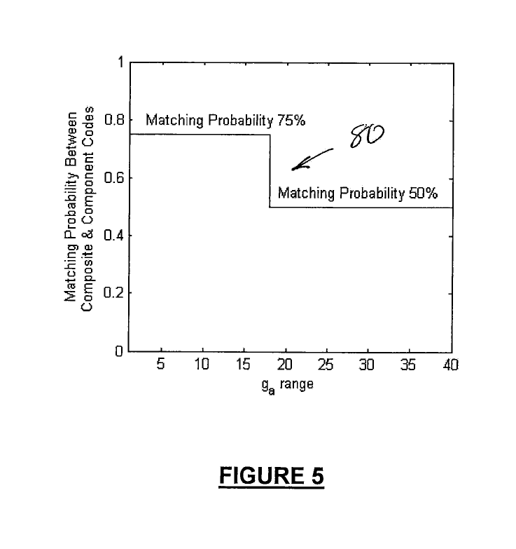

FIG. 5 shows a graph 80 indicating ranges and matching probabilities for the composite BPSK code x(t) and each of the two component BPSK codes. For gₐ<(2+\sqrt{5})² the matching probability is 75%; otherwise the matching probability is 50%. The derivation is shown below:

$$x ( t ) = sign [ 2 \sqrt{{g}_{a}} - \frac{1}{2} {g}_{a} + \frac{1}{2} ] = 0 if \\ \frac{4 \sqrt{{g}_{a}} + 1}{{g}_{a}} = 1 \\ \frac{4 \sqrt{{g}_{a}} + 1}{{g}_{a}} = 1 \\ {g}_{a} - 4 \sqrt{{g}_{a}} - 1 = 0 \qquad Equation 14$$

This is a quadratic equation and its solution is:

$$\sqrt{{g}_{a}} = \frac{4 \pm \sqrt{16 + 4}}{2} . \qquad Equation 15$$

Since gₐ can only be positive, then

\sqrt{gₐ}=2+\sqrt{5}

gₐ=(2+\sqrt{5})²

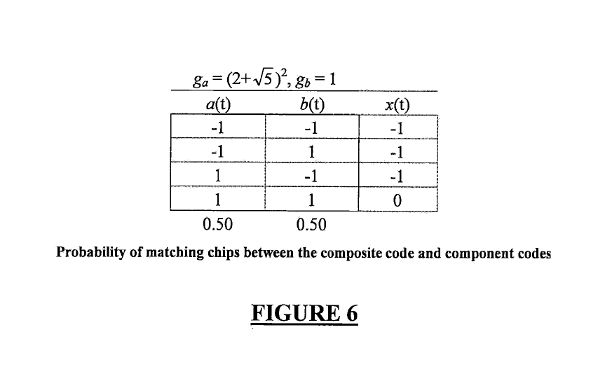

The occurrence of this equation is on the border between matching probabilities 75% and 50%, and the probability of its occurrence is very small and is negligible. The matching probabilities are shown in the table of FIG. 6. Hence the ranges for gₐ and the corresponding matching probabilities can mathematically be expressed as

$$\begin{matrix}x ( t ) = sign [ 2 \sqrt{{g}_{a}} - \frac{1}{2} {g}_{a} + \frac{1}{2} ] \\ = \{ \begin{matrix}1 and 75 \% matching & if & \frac{4 \sqrt{{g}_{a}} + 1}{{g}_{a}} > 1 \\ - 1 and 50 \% matching & if & \frac{4 \sqrt{{g}_{a}} + 1}{{g}_{a}} < 1\end{matrix}\end{matrix} \qquad Equation 16$$

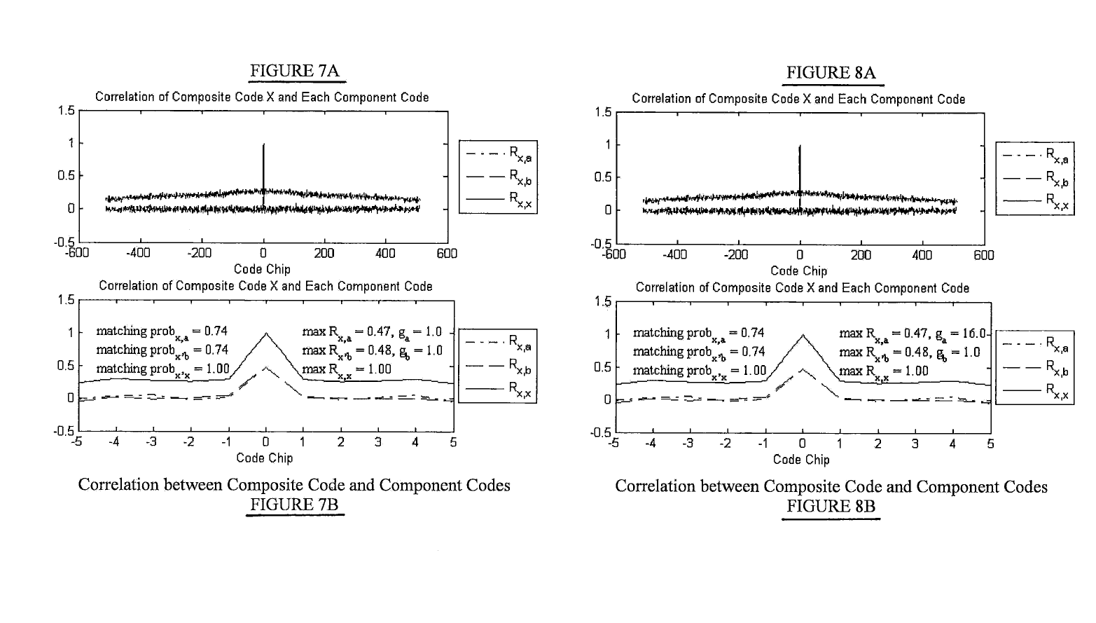

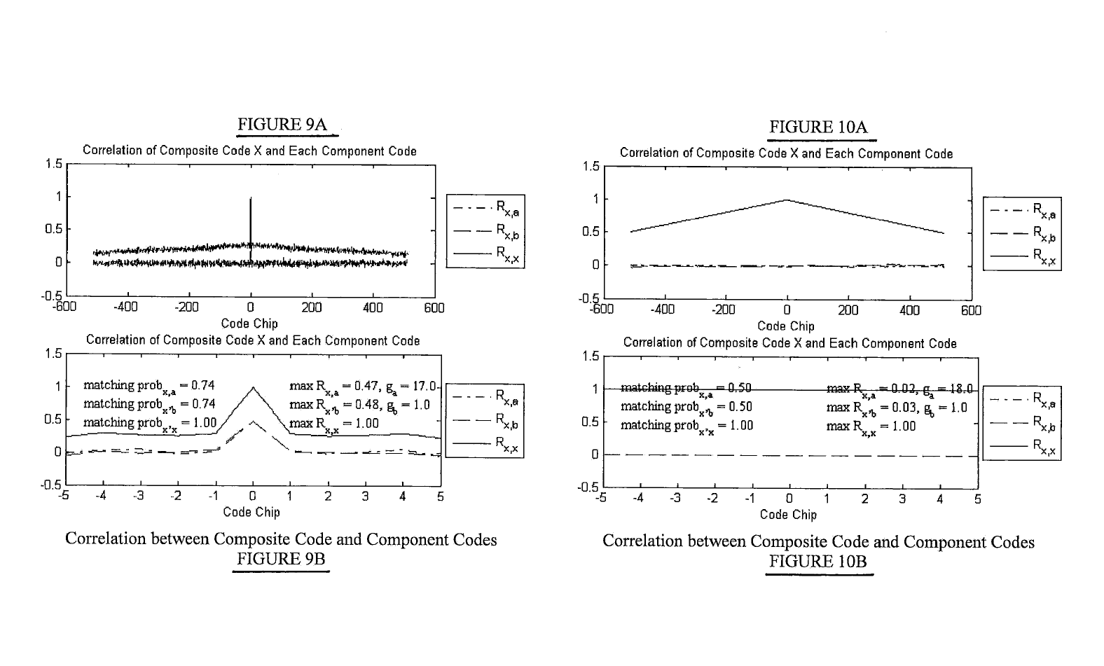

FIGS. 7A, 7B, 8A, 8B, 9A, 9B, 10A and 10B demonstrate the relationship between the matching probability and the associated correlation at various code power ratios. FIGS. 7-10 assume infinite bandwidth. Had a low-pass filter of a finite bandwidth been applied before correlation takes place, the correlation would be reduced due to out-of-band loss. The amount of reduction depends on the filter bandwidth and the chip rates of the component codes. FIGS. 7A and 7B are graphs illustrating the correlations of the composite BPSK code with itself and with the component BPSK codes. The correlation of the composite BPSK code with itself has a peak of unity since it matches itself perfectly as it should (Equation 6). The correlations of the composite BPSK code with the component BPSK codes have peaks roughly 0.5 indicating the 75% matching between the composite BPSK code and the component BPSK codes (see Equation 7). FIG. 7B is an enlarged version of FIG. 7A focusing on the details of the peaks of these correlations.

The correlations shown in FIGS. 7-9 have gain ratios in the interval of [1 . . . (2+\sqrt{5})²) in FIG. 5, and have a matching probability of roughly 75% as stated in Equation 7. The correlations in FIG. 10B are virtually zero since the code power ratios are well beyond the interval [1 . . . (2+\sqrt{5})²) in FIG. 5. The correlation of composite BPSK code x(t) in FIGS. 7 through 9 do not have zero noise floor since the composite BPSK code is not equally probable between −1 and +1.

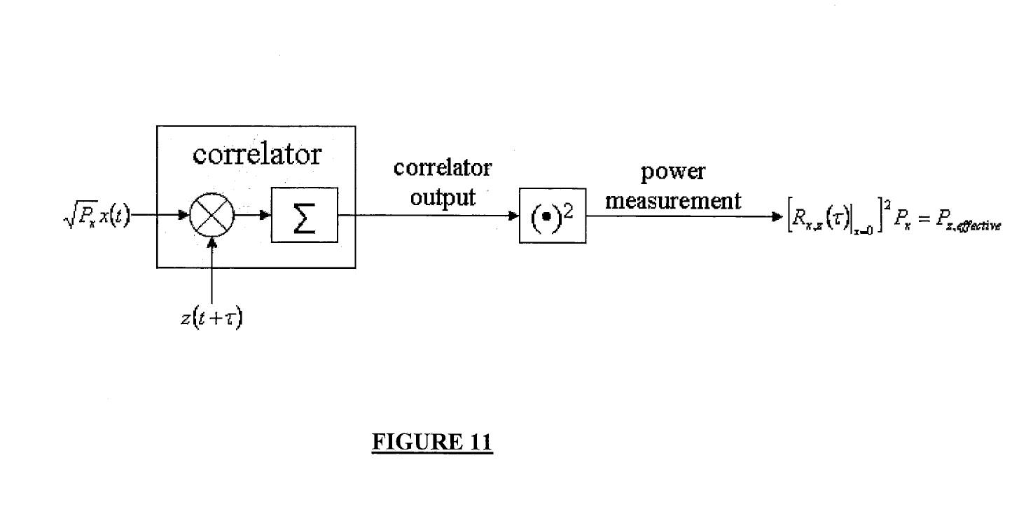

The matching probability for each component BPSK code determines the correlatable power (also known as “effective code power”) of the component code received at the output of the correlator of each component BPSK code where code z(t)=a(t) or b(t), and Pₓ is the power of the composite BPSK code x(t), Pₓ=Pₐ+P_{b}=(gₐ+1)*P_{b}. This is shown in FIG. 11.

For matching probabilities equal to 75%, the R_{x,a}(τ=0)=R_{x,b}(τ=0)=0.5 and the P_{z,effective} is 0.25 of Pₓ for each component BPSK code. This means a total of 0.5=2(0.25) of the total power of the composite BPSK code can be recovered and the power efficiency=0.5.

$${η}_{z} = \frac{{P}_{z , effective}}{{P}_{x}} = {[ {R}_{x , z} ( τ ) {\vert}_{τ = 0} ]}^{2} \\ 0.5 = η = {η}_{a} + {η}_{b} \\ ( 1 ) \qquad Equation 17$$

This demonstrates via Equation 16 that maintaining the code power ratio gₐ in a certain range will maintain each component code power efficiency η_{z} as well as the composite code efficiency η.

Due to the combining efficiency in Equation 17 not being 100%, there is a combining loss. This means the effective code power at the correlator output for each component BPSK code will not be P_{z}, but something less P_{z,effective}<P_{z}. If P_{z} is desired at the correlator output of each BPSK component code (i.e., P_{z} is expected as the effective code power at the correlator output), then the difference between P_{z,effective} (the effective code power before component BPSK code power compensation) and P_{z} (the effective code power after component BPSK code compensation) needs to be made up by some power compensation to the code. The code power compensation can be done for each component BPSK code.

For the composite BPSK code, the additional power needed for the compensation is calculated as

$${P}_{compensation} = \frac{1}{η} {P}_{x} - {P}_{x} . \qquad Equation 18$$

It will be noted that adding compensation power and maintaining code power ratios does not change the efficiencies shown in Equation 17. The compensation power defined by Equation 18 is equivalent to boosting the composite code power by a gain (1/η) and the compensated composite code power is:

$$\frac{1}{η} {P}_{x} = {P}_{x} + {P}_{compensation} = {P}_{x} + ( \frac{1}{η} {P}_{x} - {P}_{x} ) . \qquad Equation 19$$

The effective code power for a(t) after compensation can be calculated to be:

$${η}_{a} [ {P}_{x} + ( \frac{1}{η} {P}_{x} - {P}_{x} ) ] = {η}_{a} \frac{{P}_{x}}{η} = \frac{{P}_{a , effective}}{η} = {P}_{a} . \qquad Equation 20$$

Likewise, for the other component BPSK code, the effective code power after compensation can be calculated to be:

$${η}_{b} [ {P}_{x} + ( \frac{1}{η} {P}_{x} - {P}_{x} ) ] = {η}_{b} \frac{{P}_{x}}{η} = \frac{{P}_{b , effective}}{η} = {P}_{b} . \qquad Equation 21$$

If the composite BPSK code x(t) can be made available as the local replica in the correlator [i.e., z(t)=x(t)], the total power of the composite code x(t) can be recovered. For the matching probability 50%, no code power can be recovered. This feature can be used to identify that gain weighted combining of two component BPSK codes is the option being used among several different code combining methodologies. The gain weighted code combining described herein may also be applied to component codes of different chip rates. It will be appreciated that a code power and chip rate for each component BPSK code could also be remotely programmed to tailor the system 10 to meet the needs of a specific application.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A method for combining first and second component binary phase shift keying (BPSK) codes to form one composite BPSK code, comprising:
gain weighting each of said first and second component BPSK codes by its respective code power ratio to form first and second gain weighted component BPSK codes;
processing the first and second gain weighted component BPSK codes using the code power ratios to form a composite BPSK code, where the composite BPSK code has a fifty percent probability of matching each one of said component BPSK codes.

2. The method of claim 1, where the composite BPSK code has a seventy-five percent probability of matching each one of said BPSK codes.

3. The method of claim 1, wherein gain weighting (also known as code power ratio) of each of said first and second component BPSK codes comprises the operations:
assigning a(t) to represent said first BPSK code, where a(t) is a random BPSK code equally likely to be +1 or −1, and has a highest code power of said two component BPSK codes;
assigning b(t) to represent said second component BPSK code, where b(t) is a random BPSK code equally likely to be +1 or −1, and has a code power of no more than that of the other component BPSK code;
determining code power ratios using the formulas:
$${g}_{a} = \frac{code power of a ( t )}{code power of b ( t )}$$
$${g}_{b} = \frac{code power of b ( t )}{code power of b ( t )} = 1.$$

4. The method of claim 3, where wherein gₐ and g_{b} are arranged such that:
gₐ≧g_{b}=1.

5. The method of claim 4, wherein said composite BPSK code is represented by a term x(t), and wherein x(t) is determined by the formula:
$$x ( t ) = sign \{ [ \sqrt{{g}_{a}} a ( t ) + b ( t ) - \frac{1}{2} {g}_{a} - \frac{1}{2} + \sqrt{{g}_{a}} a ( t ) * b ( t ) ] \} .$$

6. The method of claim 4, further comprising determining a power efficiency of each said component BPSK code using the formula:
$${η}_{z} = \frac{{P}_{z , effective}}{{P}_{x}} = {[ {R}_{x , z} ( τ ) {\vert}_{τ = 0} ]}^{2} .$$

7. The method of claim 6, wherein:
Pₐ is a power of component code a(t);
P_{b} is a power of component code b(t);
Pₓ is a power of composite code x(t); and
Pₓ=Pₐ+P_{b}=(gₐ+1)*P_{b}.

8. The method of claim 6, further comprising compensating for a reduction in effective code power of said composite BPSK code.

9. The method of claim 5, wherein each of the plurality of component BPSK codes is represented in the composite BPSK code with a common power efficiency.

10. The method of claim 5, wherein a combining loss resulting from combining the plurality of component BPSK codes is substantially the same for each of the plurality of codes.

11. The method of claim 5, wherein the code power and chip rate of each of the plurality of component BPSK codes is remotely programmable.

12. A method for combining first and second component binary phase shift keying (BPSK) codes to form one composite BPSK code, comprising:
gain weighting each of said first and second component BPSK codes using a code power of each said component BPSK code as follows:
$${g}_{a} = \frac{code power of a ( t )}{code power of b ( t )}$$
$${g}_{b} = \frac{code power of b ( t )}{code power of b ( t )}$$
where a(t) represents said first component BPSK code, and gₐ comprises a gain weighted first component BPSK code, and
where b(t) represents said second component BPSK code, and g_{b} comprises a gain weighted second component BPSK code,
selecting an order of said BPSK codes such that gₐ>g_{b}, and g_{b} is set equal to 1; and
processing the first and second gain weighted component BPSK codes to form a single, composite BPSK code that is representative of the two component BPSK codes.

13. The method of claim 12, wherein said composite BPSK code has a greater than fifty percent probability of matching each one of said component BPSK codes over four unique chips formed by said two component BPSK codes.

14. The method of claim 12, where the composite BPSK code has approximately a fifty percent to seventy-five percent probability of matching each of said component BPSK codes over said four unique chips formed by said two component BPSK codes.

15. The method of claim 12, wherein said composite BPSK code is represented by a term x(t), and wherein x(t) is determined by the formula:
$$x ( t ) = sign \{ [ \sqrt{{g}_{a}} a ( t ) + b ( t ) - \frac{1}{2} {g}_{a} - \frac{1}{2} + \sqrt{{g}_{a}} a ( t ) * b ( t ) ] \} .$$

16. The method of claim 12, further comprising determining a power efficiency of each said component BPSK code for use in compensating for a power loss associated with each said component BPSK code.

17. The method of claim 16, wherein:
Pₐ is a power of first component BPSK code a(t);
P_{b} is a power of second component BPSK code b(t);
Pₓ is a power of composite BPSK code x(t); and
P_{x=P}ₐ+P_{b}=(gₐ+1)*P_{b}.

18. The method of claim 17, further comprising compensating for a reduction in code power of said composite BPSK code.

19. A method for combining first and second binary phase shift keying (BPSK) codes to form one composite BPSK code, comprising:
gain weighting each of said first and second component BPSK codes such that:
a(t) represents said first component BPSK code, and \sqrt{gₐ}a(t) comprises a gain weighted first component BPSK code;
b(t) represents said second component BPSK code, and \sqrt{g_{b}}b(t) comprises a gain weighted second component BPSK code;
designating said component BPSK codes such that gₐ≧g_{b} and g_{b} is set equal to 1; and
processing the first and second gain weighted component BPSK codes in accordance with an algorithm:
$$x ( t ) = sign \{ [ \sqrt{{g}_{a}} a ( t ) + b ( t ) - \frac{1}{2} {g}_{a} - \frac{1}{2} + \sqrt{{g}_{a}} a ( t ) * b ( t ) ] \}$$
where x(t) represents said composite BPSK code that is representative of the two component BPSK codes a(t) and b(t).

20. The method of claim 19, wherein said first and second gain weightings of component BPSK codes gₐ, and g_{b}, are determined in accordance with the algorithms:
$${g}_{a} = \frac{code power of a ( t )}{code power of b ( t )}$$
$${g}_{b} = \frac{code power of b ( t )}{code power of b ( t )} = 1.$$

21. The method of claim 19, further comprising determining a power efficiency of each said component BPSK code for use in compensating for a power loss associated with each said component BPSK code.

22. The method of claim 21, wherein a code power of the composite BPSK code x(t) is determined by:
where Pₐ is a power of component BPSK code a(t);
where P_{b} is a power of component BPSK code b(t);
where Pₓ is a power of composite BPSK code x(t); and
Pₓ=Pₐ+P_{b}=(gₐ+1)*P_{b}.

23. A system for generating a single, composite binary phase shift keying (BPSK) code that is representative of each one of a pair of component BPSK codes, the system comprising:
a square root determining circuit for taking a square root of an input representing a code power ratio gₐ;
a first multiplier circuit responsive to an output of said square root determining circuit and to an input a(t);
a second multiplier circuit and a first summing circuit each responsive in part to an output from said first multiplier circuit, said second multiplier circuit being responsive to an input b(t);
a second summing circuit for summing said code power ratio gₐ and a constant;
a third multiplier circuit for multiplying an output of said second summing circuit with a constant;
a third summing circuit for summing an output of said third multiplier circuit and said input b(t);
a fourth summing circuit for summing an output of said third summing circuit and said first summing circuit;
a threshold circuit for comparing an output of said fourth summing circuit against a zero threshold; and
said square root determining circuit, said multiplier circuits, said summing circuits and said zero threshold circuit adapted to execute an algorithm comprising:
$$x ( t ) = sign \{ [ \sqrt{{g}_{a}} a ( t ) + b ( t ) - \frac{1}{2} {g}_{a} - \frac{1}{2} + \sqrt{{g}_{a}} a ( t ) * b ( t ) ] \}$$
where a(t) represents a first component BPSK code, and \sqrt{gₐ}a(t) comprises a gain weighted first component BPSK code;
where b(t) represents said second component BPSK code, and \sqrt{g_{b}}b(t) comprises a gain weighted second component BPSK code (since g_{b}=1, the gain weighted second component BPSK code is b(t)); and
where an order of said component BPSK codes has been selected such that gₐ≧g_{b}, and g_{b} is set equal to 1.
